(19) United States
(12) Patent Application Publication
(10) Pub. No.: US 2022/0365345 A1
(43) Pub. Date: Nov. 17, 2022

(54) HEAD-UP DISPLAY AND PICTURE DISPLAY SYSTEM

(71) Applicant: KOITO MANUFACTURING CO., LTD., Tokyo (JP)

(72) Inventor: Yuri Hamada, Shizuoka (JP)

(73) Assignee: KOITO MANUFACTURING CO., LTD., Tokyo (JP)

(21) Appl. No.: 17/761,865

(22) PCT Filed: Sep. 14, 2020
(86) PCT No.: PCT/JP2020/034664

§ 371 Date: Mar. 18, 2022

(30) Foreign Application Priority Data
Sep. 19, 2019 (JP) 2019-170539

(51) Int. Cl. G02B 27/01; B60K 35/00

(52) U.S. Cl. CPC G02B 27/0101; B60K 35/00; G02B 2027/0138; B60K 2370/1529; B60K 2370/23; B60K 2370/21

(57) ABSTRACT

A head-up display includes a picture generation unit configured to emit first light for generating a first picture at a position away from a vehicle by a predetermined distance and second light for generating a second picture at a position away from the vehicle by a distance different from the predetermined distance; and a reflection unit configured to reflect the first light and the second light so that the first light and the second light are radiated to a windshield. A first optical element that reduces transmittance of light including at least visible light to be lower than transmittance of the first light is provided between the picture generation unit and the windshield at a position through which the second light passes.

### TECHNICAL FIELD

The present invention relates to a head-up display and a picture display system.

### BACKGROUND ART

In the future, it is expected that a vehicle traveling in an automatic driving mode and a vehicle traveling in a manual driving mode coexist on a public road.

In a future automatic driving society, it is expected that visual communication between a vehicle and a person becomes more important. For example, it is expected that visual communication between a vehicle and an occupant of the vehicle becomes more important. In this regard, the visual communication between the vehicle and the occupant can be implemented using a head-up display (HUD). The head-up display can achieve so-called augmented reality (AR) by projecting a picture or a video on a windshield or a combiner, superimposing the picture on a real space through the windshield or the combiner, and enabling the occupant to visually recognize the picture.

As an example of the head-up display, Patent Literature 1 discloses a display device including an optical system for displaying a stereoscopic virtual picture by using a transparent display medium. The display device projects light onto a windshield or a combiner in a field of view of a driver. A part of the projected light passes through the windshield or the combiner, and the other part is reflected by the windshield or the combiner. The reflected light is directed to eyes of the driver. The driver perceives the reflected light that enters the eyes of the driver as a virtual picture that appears to be a picture of an object at an opposite side (outside of an automobile) of the windshield or the combiner against a background of a real object that can be seen through the windshield or combiner.

When external light such as sunlight enters an inner side of the head-up display, the external light is converged by a display device and causes a local temperature rise, which may lead to disturbance of picture display or heat damage to the display device. In order to prevent such a problem, Patent Literature 2 discloses a configuration in which heat dissipation of a display device is improved and a configuration in which a plate that reflects infrared rays is provided between the display device and a reflection unit. In Patent Literature 2, a component for preventing the temperature rise of the display device is separately required, which leads to an increase in costs.

### CITATION LIST

### Patent Literature

Patent Literature 1: JP-A-2018-45103

Patent Literature 2: JP-A-2005-313733

### SUMMARY OF INVENTION

### Technical Problem

An object of the present invention is to provide a head-up display and a picture display system that can prevent the occurrence of heat damage caused by external light without greatly reducing quality of generating a picture to be displayed to an occupant.

### Solution to Problem

In order to achieve the above object, according to one aspect of the present invention, there is provided a head-up display.

The head-up display is provided in a vehicle and configured to display predetermined pictures toward an occupant of the vehicle, the head-up display including:

a picture generation unit configured to emit first light for generating a first picture at a position away from the vehicle by a predetermined distance, and second light for generating a second picture at a position away from the vehicle by a distance different from the predetermined distance, among the predetermined pictures; and

a reflection unit configured to reflect the first light and the second light so that the first light and the second light emitted by the picture generation unit are radiated to a windshield or a combiner.

A first optical element that reduces transmittance of light including at least visible light to be lower than transmittance of the first light is provided between the picture generation unit and the windshield or the combiner at a position through which the second light passes.

According to the above configuration, it is possible to provide a head-up display that can prevent the occurrence of heat damage caused by external light without greatly reducing quality of the second picture among the first picture and the second picture to be displayed to an occupant.

According to another aspect of the present invention, there is provided a picture display system. The picture display system including:

the head-up display according to the above aspect;

an IR lamp configured to radiate infrared light to an outer side of the vehicle; and

an IR camera configured to capture a picture of the outer side of the vehicle irradiated with the infrared light.

The second picture is generated based on the picture captured by the IR camera.

According to the above configuration, since the second picture can be used even in a situation where the surroundings of the vehicle are dark, the second picture can be used as a picture for night vision.

### Advantageous Effects of Invention

According to the present invention, it is possible to provide a head-up display and a picture display system that can prevent the occurrence of heat damage caused by external light without greatly reducing quality of generating a picture to be displayed to an occupant.

### BRIEF DESCRIPTION OF RENDERINGS

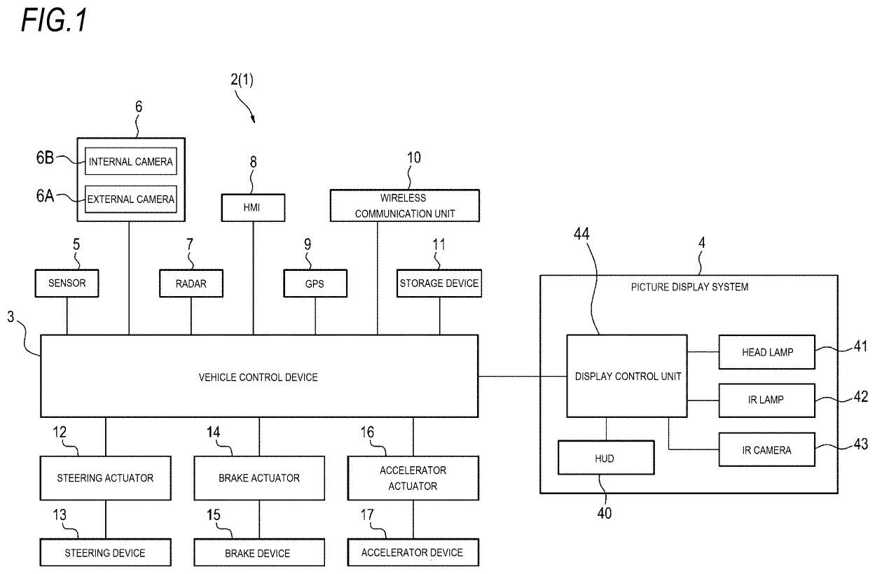

FIG. 1 is a block diagram showing a vehicle system including a picture display system according to an embodiment.

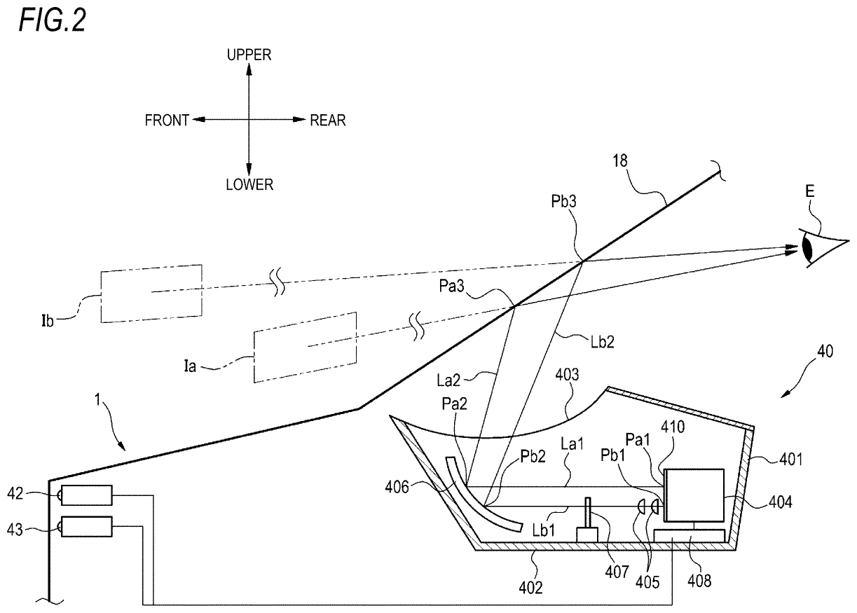

FIG. 2 is a schematic diagram showing a head-up display (HUD) according to a first embodiment provided in the picture display system.

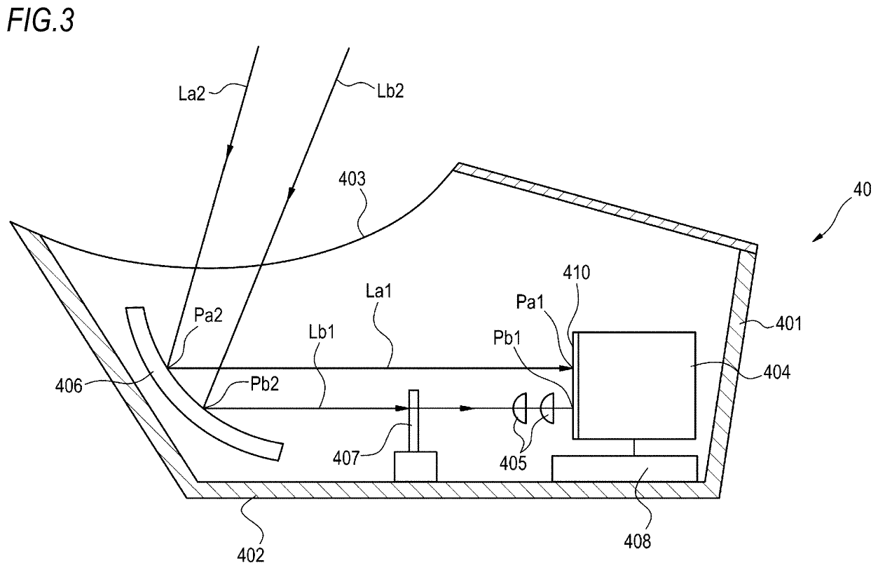

FIG. 3 is a schematic diagram showing a function of an ND filter in the HUD.

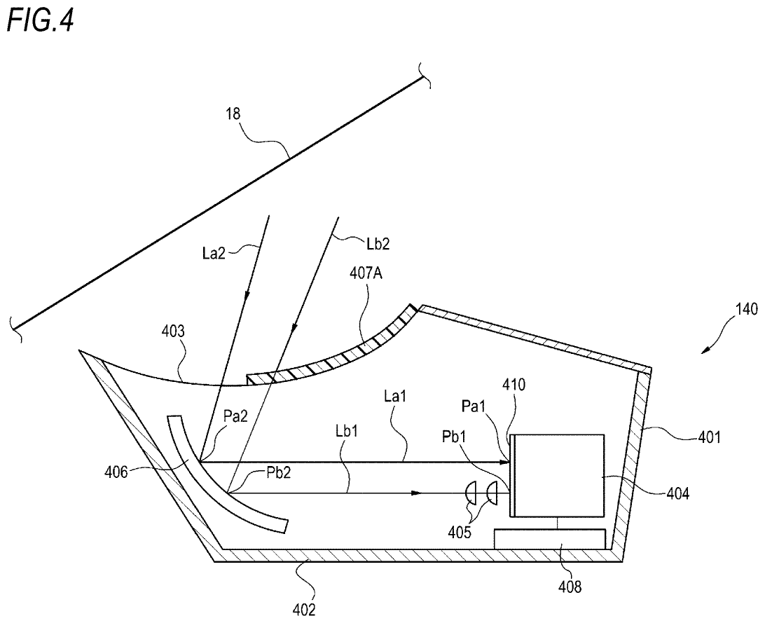

FIG. 4 is a schematic diagram showing a function of an ND filter in an HUD according to a second embodiment.

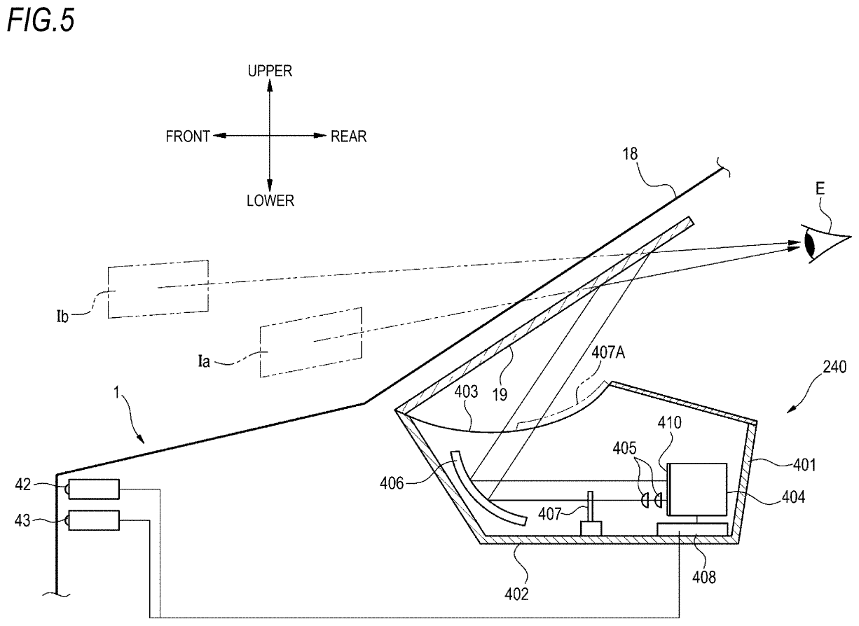

FIG. 5 is a schematic diagram showing an HUD according to a modification.

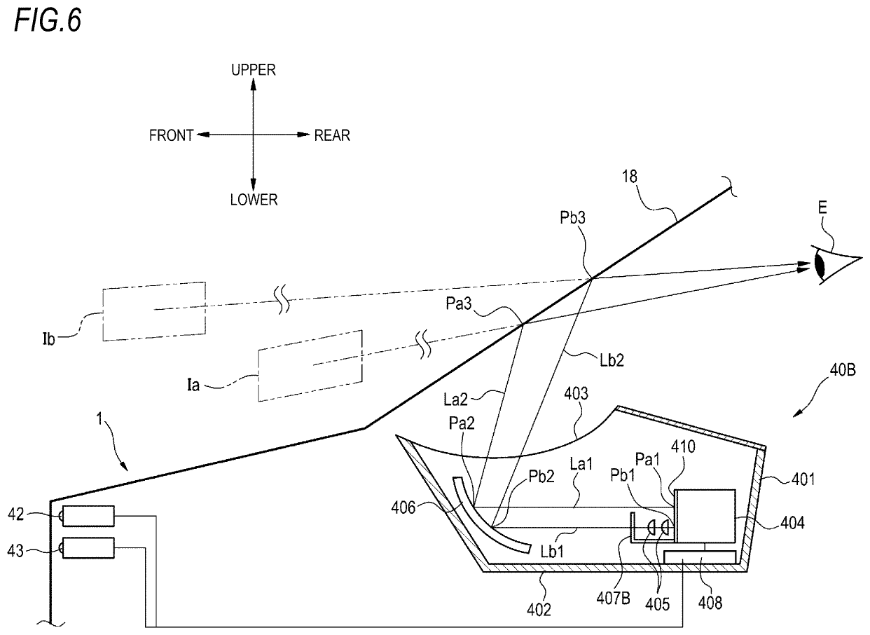

FIG. 6 is a schematic diagram showing an HUD according to another modification.

### DESCRIPTION OF EMBODIMENTS

Hereinafter, an embodiment of the present invention (hereinafter, referred to as the present embodiment) will be described with reference to the drawings. Dimensions of members shown in the drawings may be different from actual dimensions of the members for the sake of convenience of description.

In the description of the present embodiment, a “left-right direction”, an “upper-lower direction”, and a “front-rear direction” may be appropriately referred to for the convenience of description. These directions are relative directions set for a head-up display (HUD) 40 shown in FIG. 2. Here, the “left-right direction” is a direction including a “left direction” and a “right direction”. The “upper-lower direction” is a direction including an “upper direction” and a “lower direction”. The “front-rear direction” is a direction including a “front direction” and a “rear direction”. Although not shown in FIG. 2, the left-right direction is a direction orthogonal to the upper-lower direction and the front-rear direction.

First, a vehicle system 2 including a picture display system 4 according to the present embodiment will be described with reference to FIG. 1. FIG. 1 is a block diagram showing the vehicle system 2. A vehicle 1 equipped with the vehicle system 2 is a vehicle (an automobile) that can travel in an automatic driving mode.

As shown in FIG. 1, the vehicle system 2 includes a vehicle control unit 3, a picture display system 4, a sensor 5, a camera 6, a radar 7, a human machine interface (HMI) 8, a global positioning system (GPS) 9, a wireless communication unit 10, and a storage device 11. The vehicle system 2 further includes a steering actuator 12, a steering device 13, a brake actuator 14, a brake device 15, an accelerator actuator 16, and an accelerator device 17.

The vehicle control unit 3 controls traveling of the vehicle 1. The vehicle control unit 3 includes, for example, at least one electronic control unit (ECU). The electronic control unit includes a computer system (for example, a system on chip (SoC) or the like) including one or more processors and memories, and an electronic circuit including an active element such as a transistor and a passive element such as a resistor. The processor includes, for example, at least one of a central processing unit (CPU), a micro processing unit (MPU), a graphics processing unit (GPU), and a tensor processing unit (TPU). The CPU may be configured with a plurality of CPU cores. The GPU may be configured with a plurality of GPU cores. The memory includes a read only memory (ROM) and a random access memory (RAM). The ROM may store a vehicle control program. For example, the vehicle control program may include an artificial intelligence (AI) program for automatic driving. The AI program is a program (learned model) constructed by supervised or unsupervised machine learning (in particular, deep learning) using a multi-layer neural network. The RAM may temporarily store a vehicle control program, vehicle control data, and/or surrounding environment information indicating a surrounding environment of the vehicle 1. The processor may be configured to load a program designated from various vehicle control programs stored in the ROM onto the RAM and execute various types of processing in cooperation with the RAM. The computer system may be configured with a non-Von Neumann computer such as an application specific integrated circuit (ASIC) and a field-programmable gate array (FPGA). Further, the computer system may be a combination of a Von Neumann computer and a non-Von Neumann computer.

The picture display system 4 is configured to generate a predetermined picture to be displayed by the HUD 40. The picture display system 4 includes an HUD 40, a head lamp 41, an IR lamp 42, an IR camera 43, and a display control unit 44.

The HUD 40 displays predetermined information (hereinafter, referred to as HUD information) as a picture toward an occupant in a manner in which the HUD information is superimposed on a real space outside the vehicle 1 (in particular, a surrounding environment in front of the vehicle 1). The HUD information displayed by the HUD 40 is, for example, vehicle traveling information related to the traveling of the vehicle 1 and/or surrounding environment information related to a surrounding environment of the vehicle 1 (in particular, information related to an object present outside the vehicle 1). The HUD 40 is an AR display that functions as a visual interface between the vehicle 1 and the occupant. At least a part of the HUD 40 is located inside the vehicle 1. Specifically, the HUD 40 is installed at a predetermined position inside the vehicle 1. For example, the HUD 40 may be disposed inside a dashboard of the vehicle 1.

The head lamp 41 is disposed at a left side and a right side of a front surface of the vehicle 1, and includes a low beam lamp configured to radiate a low beam to a front side of the vehicle 1 and a high beam lamp configured to radiate a high beam to the front side of the vehicle 1. Each of the low beam lamp and the high beam lamp includes one or more light emitting elements such as a light emitting diode (LED) and a laser diode (LD), and an optical member such as a lens and a reflector. The head lamp 41 is connected to the display control unit 44.

The IR lamp 42 is disposed on, for example, a front surface of the vehicle 1, and is configured to radiate infrared light to a front side outside of the vehicle 1. The IR lamp 42 is connected to the display control unit 44.

Similar to the IR lamp 42, the IR camera 43 is disposed on, for example, the front surface of the vehicle 1. The IR camera 43 is configured to capture a picture of a surrounding building irradiated with the infrared light of the IR lamp 42, and an object (a pedestrian, another vehicle, a sign, or the like) on a road surface. The IR camera 43 is connected to the display control unit 44. The IR camera 43 may be provided as an example of an external camera 6A.

The display control unit 44 is configured to control operations of the HUD 40, the head lamp 41, the IR lamp 42, and the IR camera 43. For example, the display control unit 44 controls the IR lamp 42 to radiate infrared light and controls the IR camera 43 to capture a picture of an outer side of the vehicle 1 irradiated with the infrared light. The display control unit 44 transmits the infrared picture captured by the IR camera 43 to the HUD 40. The display control unit 44 is configured with an electronic control unit (ECU). The electronic control unit includes a computer system (for example, a SoC or the like) including one or more processors and memories, and an electronic circuit including an active element such as a transistor and a passive element such as a resistor. The processor includes at least one of a CPU, an MPU, a GPU, and a TPU. The memory includes a ROM and a RAM. The computer system may be configured with a non-Von Neumann computer such as an ASIC and an FPGA.

Although the vehicle control unit 3 and the display control unit 44 are provided as separate bodies in the present embodiment, the vehicle control unit 3 and the display control unit 44 may be provided as an integrated body. In this regard, the display control unit 44 and the vehicle control unit 3 may be configured with a single electronic control unit. The display control unit 44 may include two electronic control units, that is, an electronic control unit configured to control an operation of the HUD 40 and an electronic control unit configured to control operations of the head lamp 41, the IR lamp 42, and the IR camera 43.

The sensor 5 includes at least one of an acceleration sensor, a speed sensor, and a gyro sensor. The sensor 5 detects a traveling state of the vehicle 1 and outputs traveling state information to the vehicle control unit 3. The sensor 5 may further include a seating sensor that detects whether a driver is seated in a driver seat, a face orientation sensor that detects the orientation of the face of the driver, an external weather sensor that detects an external weather condition, a human sensor that detects whether there is a person in the vehicle, and the like.

The camera 6 is, for example, a camera including an imaging element such as a charge-coupled device (CCD) and a complementary MOS (CMOS). The camera 6 includes the external camera 6A and an internal camera 6B.

The external camera 6A is configured to acquire picture data indicating a surrounding environment of the vehicle 1 and then transmit the picture data to the vehicle control unit 3. The vehicle control unit 3 acquires surrounding environment information based on the picture data transmitted from the external camera 6A. Here, the surrounding environment information may include information related to an object (a pedestrian, another vehicle, a sign or the like) present outside the vehicle 1. For example, the surrounding environment information may include information related to an attribute of an object present outside the vehicle 1 and information related to a distance or a position of the object relative to the vehicle 1. The external camera 6A may be configured as a monocular camera, or may be configured as a stereo camera.

The internal camera 6B is disposed inside the vehicle 1 and is configured to acquire picture data indicating an occupant. The internal camera 6B functions as, for example, an eye tracking camera that tracks a viewpoint E (to be described later in FIG. 2) of the occupant. The internal camera 6B is provided, for example, in the vicinity of a rear-view mirror, inside an instrument panel, or the like.

The radar 7 includes at least one of a millimeter wave radar, a microwave radar, and a laser radar (for example, a LiDAR unit). For example, the LiDAR unit is configured to detect a surrounding environment of the vehicle 1. In particular, the LiDAR unit is configured to acquire 3D mapping data (point cloud data) indicating the surrounding environment of the vehicle 1 and then transmit the 3D mapping data to the vehicle control unit 3. The vehicle control unit 3 specifies the surrounding environment information based on the 3D mapping data transmitted from the LiDAR unit.

The HMI 8 includes an input unit that receives an input operation from a driver, and an output unit that outputs traveling information or the like to the driver. The input unit includes a steering wheel, an accelerator pedal, a brake pedal, a driving mode switch that switches a driving mode of the vehicle 1, and the like. The output unit is a display (excluding the HUD) that displays various kinds of traveling information.

The GPS 9 is configured to acquire current position information of the vehicle 1 and output the acquired current position information to the vehicle control unit 3.

The wireless communication unit 10 receives information (for example, traveling information) related to another vehicle present surrounding the vehicle 1 from the another vehicle and transmits information (for example, traveling information) related to the vehicle 1 to the another vehicle (vehicle-to-vehicle communication). The wireless communication unit 10 is configured to receive infrastructure information from an infrastructure facility such as traffic lights or a sign lamp and transmit traveling information about the vehicle 1 to the infrastructure facility (road-to-vehicle communication). The wireless communication unit 10 is configured to receive information related to a pedestrian from a portable electronic device (a smart phone, a tablet, a wearable device or the like) carried by the pedestrian and transmit own vehicle traveling information of the vehicle 1 to the portable electronic device (pedestrian-vehicle communication). The vehicle 1 may directly communicate with another vehicle, the infrastructure facility, or the portable electronic device in an ad-hoc mode, or may communicate with another vehicle, the infrastructure equipment, or the portable electronic device via an access point. Further, the vehicle 1 may communicate with another vehicle, the infrastructure facility, or the portable electronic device via a communication network (not shown). The communication network includes at least one of the Internet, a local area network (LAN), a wide area network (WAN), and a radio access network (RAN). A radio communication standard is, for example, Wi-Fi (registered trademark), Bluetooth (registered trademark), ZigBee (registered trademark), IPWA, DSRC (registered trademark) or Li-Fi. Further, the vehicle 1 may communicate with another vehicle, the infrastructure facility, or the portable electronic device by using a fifth generation mobile communication system (5G).

The storage device 11 is an external device such as a hard disk drive (HDD) and a solid state drive (SSD). The storage device 11 may store two-dimensional or three-dimensional map information and/or a vehicle control program. For example, the three-dimensional map information may be configured with 3D mapping data (point cloud data). The storage device 11 is configured to output the map information and the vehicle control program to the vehicle control unit 3 in response to a request from the vehicle control unit 3. The map information and the vehicle control program may be updated via the wireless communication unit 10 and the communication network.

When the vehicle 1 travels in an automatic driving mode, the vehicle control unit 3 automatically generates at least one of a steering control signal, an accelerator control signal, and a brake control signal based on the traveling state information, the surrounding environment information, the current position information, the map information, and the like. The steering actuator 12 is configured to receive the steering control signal from the vehicle control unit 3 and control the steering device 13 based on the received steering control signal. The brake actuator 14 is configured to receive the brake control signal from the vehicle control unit 3 and control the brake device 15 based on the received brake control signal. The accelerator actuator 16 is configured to receive the accelerator control signal from the vehicle control unit 3 and control the accelerator device 17 based on the received accelerator control signal. In this manner, the vehicle control unit 3 automatically controls the traveling of the vehicle 1 based on the traveling state information, the surrounding environment information, the current position information, the map information, and the like. That is, the traveling of the vehicle 1 is automatically controlled by the vehicle system 2 in the automatic driving mode.

On the other hand, when the vehicle 1 travels in a manual driving mode, the vehicle control unit 3 generates a steering control signal, an accelerator control signal, and a brake control signal in accordance with a manual operation of the driver on an accelerator pedal, a brake pedal, and a steering wheel. In this manner, since the steering control signal, the accelerator control signal, and the brake control signal are generated by a manual operation of the driver in the manual driving mode, the traveling of the vehicle 1 is controlled by the driver.

As described above, the driving modes include the automatic driving mode and the manual driving mode. The automatic driving mode includes, for example, a fully automatic driving mode, an advanced driving support mode, and a driving support mode. In the fully automatic driving mode, the vehicle system 2 automatically performs all kinds of traveling controls including a steering control, a brake control, and an accelerator control, and the driver cannot drive the vehicle 1. In the advanced driving support mode, the vehicle system 2 automatically performs all kinds of traveling controls including a steering control, a brake control, and an accelerator control, and the driver can drive the vehicle 1 but does not drive the vehicle 1. In the driving support mode, the vehicle system 2 automatically performs a part of the traveling controls including a steering control, a brake control, and an accelerator control, and the driver drives the vehicle 1 under the driving support of the vehicle system 2. On the other hand, in the manual driving mode, the vehicle system 2 does not automatically perform the traveling controls, and the driver drives the vehicle 1 without the driving support of the vehicle system 2.

### First Embodiment

FIG. 2 is a schematic diagram showing the HUD 40 according to the first embodiment as viewed from a side surface of the vehicle 1. As shown in FIG. 2, the HUD 40 includes an HUD main body 401. The HUD main body 401 includes a housing 402 and an emission window 403. The emission window 403 is formed of a transparent plate that transmits light. The HUD main body 401 includes a picture generation unit (PGU) 404, a lens 405 (an example of a second optical element), a concave mirror 406 (an example of a reflection unit), a neutral density (ND) filter 407 (an example of a first optical element), and a control board 408, which are accommodated inside the housing 402.

The picture generation unit 404 is configured to emit light for generating predetermined pictures to be displayed toward an occupant of the vehicle 1. Although not shown in detail, the picture generation unit 404 includes a light source, an optical component, and a display device. The light source is, for example, a laser light source or an LED light source. The laser light source is, for example, an RGB laser light source configured to emit red laser light, green light laser light, and blue laser light. The optical component appropriately includes a prism, a lens, a diffusion plate, a magnifying glass, and the like. The optical component transmits the light emitted from the light source and emits the light toward the display device. The display device is a liquid crystal display, a digital mirror device (DMD), or the like. A drawing method of the picture generation unit 404 may be a raster scan method, a digital light processing (DLP) method, or a liquid crystal on silicon (LCOS) method. When the DLP method or the LCOS method is employed, the light source of the HUD 40 may be an LED light source. When a liquid crystal display method is employed, the light source of the HUD 40 may be a white LED light source.

The lens 405 is disposed between the picture generation unit 404 and the concave mirror 406. The lens 405 is configured to change a focal length of light emitted from a light emission surface 410 of the picture generation unit 404. The lens 405 is provided at a position through which a part of the light that is emitted from the light emission surface 410 of the picture generation unit 404 and travels toward the concave mirror 406 passes. The lens 405 may include, for example, a drive unit, and may be configured to change a distance to the picture generation unit 404 in accordance with a control signal generated by the control board 408. The lens 405 is moved so as to change the focal length (apparent optical path length) of the light emitted from the picture generation unit 404, and a distance between a windshield 18 and a predetermined picture to be displayed by the HUD 40. An optical element such as a mirror may be used instead of the lens.

The concave mirror 406 is disposed on an optical path of the light emitted from the light emission surface 410 of the picture generation unit 404. The concave mirror 406 is configured to reflect light emitted from the light emission surface 410 toward the windshield 18 (for example, a front window of the vehicle 1). The concave mirror 406 has a reflecting surface that is curved into a concave shape in order to form a predetermined picture, and reflects a picture of the light that is emitted from the light emission surface 410 and is used to form a picture at a predetermined magnification. The concave mirror 406 includes a drive mechanism (not shown). The drive mechanism can rotate an orientation of the concave mirror 406 based on a control signal transmitted from the control board 408.

The ND filter 407 is an optical filter disposed between the picture generation unit 404 and the concave mirror 406. The ND filter 407 is provided at a position through which a part of the light that is emitted from the light emission surface 410 of the picture generation unit 404 and travels toward the concave mirror 406 passes. Specifically, the ND filter 407 is provided at a position through which the light that was emitted from the light emission surface 410 and passed through the lens 405 passes. The ND filter 407 is provided at a position through which a part of external light that is incident into the vehicle 1 from an outer side, is reflected by the concave mirror 406, and travels toward the light emission surface 410 of the picture generation unit 404 passes. The ND filter 407 reduces the transmittance of light (for example, sunlight) including at least visible light among the light passing through the ND filter 407. For example, the ND filter 407 is configured to reduce the transmittance of the light passing through the ND filter 407 to 1% or more and 40% or less. The ND filter 407 is most effective when the transmittance of the light passing through the ND filter 407 can be reduced to 1.7% or more and 15% or less, and preferably 10% or less. The ND filter 407 is attached to the housing 402. The optical filter is not limited to the ND filter, and may be any optical filter capable of reducing the transmittance (light amount) of external light.

The control board 408 is configured to control the operation of the picture generation unit 404. The control board 408 is provided with a processor such as a central processing unit (CPU) and a memory, and the processor executes a computer program read from the memory to control the operation of the picture generation unit 404. For example, the control board 408 generates a control signal for controlling the operation of the picture generation unit 404 based on the vehicle traveling information, the surrounding environment information, and the like transmitted from the vehicle control unit 3 via the display control unit 44, and transmits the generated control signal to the picture generation unit 404. The control board 408 generates a control signal for controlling the operation of the picture generation unit 404 based on the infrared picture transmitted from the display control unit 44, and transmits the generated control signal to the picture generation unit 404. Further, the control board 408 may control and change the orientation of the concave mirror 406.

Although the control board 408 and the display control unit 44 are provided separately in the present embodiment, the control board 408 may be configured as a part of the display control unit 44.

Light emitted from the picture generation unit 404 is reflected by the concave mirror 406 and is emitted from the emission window 403 of the HUD main body 401. The light emitted from the emission window 403 of the HUD main body 401 is radiated to the windshield 18. A part of the light radiated to the windshield 18 is reflected toward the viewpoint E of an occupant. As a result, the occupant recognizes the light emitted from the HUD main body 401 as a virtual picture (an example of a predetermined picture) formed at a predetermined distance in front of the windshield 18. In this manner, the picture displayed by the HUD 40 is superimposed on a real space in front of the vehicle 1 through the windshield 18, so that the occupant can visually recognize virtual picture objects Ia and Ib formed by the virtual picture (picture) in a manner in which the virtual picture objects Ia and Ib float on a road located outside the vehicle.

For example, the light (an example of first light) emitted from a point Pa1 on the light emission surface 410 of the picture generation unit 404 travels along an optical path La1, is reflected at a point Pa2 on the concave mirror 406, thereafter travels along an optical path La2, and is emitted to the outside of the HUD 40 from the emission window 403 of the HUD main body 401. The light traveling along the optical path La2 is incident onto a point Pa3 of the windshield 18, thereby forming a part of the virtual picture object Ia (an example of a first picture) formed by a predetermined picture. The virtual picture object Ia is formed, for example, at a front side away from the windshield 18 by a relatively short predetermined distance (for example, about 3 m).

On the other hand, the light (an example of second light) emitted from a point Pb1 on the light emission surface 410 of the picture generation unit 404 passes through the lens 405 and the ND filter 407, and then travels along an optical path Lb1. The light emitted from the point Pb1 passes through the lens 405, so that a focal length of the light is changed. That is, the light emitted from the point Pb1 passes through the lens 405, so that an apparent optical path length is changed. The light emitted from the point Pb1 passes through the ND filter 407, so that a light amount is reduced. The light traveling along the optical path Lb1 is reflected at a point Pb2 on the concave mirror 406, thereafter travels along an optical path Lb2, and is emitted to the outside of the HUD 40 from the emission window 403 of the HUD main body 401. The light traveling along the optical path Lb2 is incident onto a point Pb3 of the windshield 18 to form a part of the virtual picture object Ib (an example of a second picture) formed by a predetermined picture. As compared with the virtual picture object Ia, for example, the virtual picture object Ib is formed at a front side away from the windshield 18 by a longer distance (for example, about 15 m). The distance of the virtual picture object Ib (the distance from the windshield 18 to the virtual picture) can be adjusted as appropriate by adjusting a position of the lens 405.

The picture displayed as the virtual picture object Ib is a picture generated based on a picture captured by the IR camera 43. Specifically, the picture displayed as the virtual picture object Ib is a picture for night vision displayed, for example, during nighttime when the surroundings of the vehicle 1 are dark. The picture displayed as the virtual picture object Ib includes, for example, a picture that is generated by imitating an object in a real space, such as a pedestrian, another vehicle, and a sign, which are captured by the IR camera 43. These generated pictures are displayed, for example, in a manner of being superimposed on the object in a real space, such as a pedestrian, another vehicle, and a sign. The generated picture may not necessarily be displayed in a manner of being superimposed on an object in a real space. For example, in a case where the object is a pedestrian, a humanoid mark imitating the pedestrian may be displayed in a blinking manner in the vicinity of the object. On the other hand, the picture displayed as the virtual picture object Ia includes, for example, a picture of a speed, a rotation speed of an engine, and the like, which can be constantly displayed during daytime and nighttime.

When a 2D picture (planar picture) is formed as the virtual picture objects Ia and Ib, a predetermined picture is projected as a virtual picture at a determined single distance. When a 3D picture (stereoscopic picture) is formed as the virtual picture objects Ia and Ib, a plurality of predetermined pictures that are the same as one another or different from one another are projected as virtual pictures at different distances.

Next, the ND filter 407 that reduces an amount of external light incident on the picture generation unit 404 will be described with reference to FIG. 3. FIG. 3 is a schematic diagram showing a function of the ND filter 407 in the HUD 40.

FIG. 3 shows a state in which external light such as sunlight that is incident into the housing 402 from the outside of the vehicle 1 is reflected by the concave mirror 406 and is incident onto the point Pa1 and the point Pb1 on the light emission surface 410 of the picture generation unit 404. As described above, the point Pa1 on the light emission surface 410 and the vicinity of the point Pa1 are regions for emitting light for forming the virtual picture object Ia at a front side away from the windshield 18 by a relatively short predetermined distance (for example, about 3 m). As described above, the point Pb1 on the light emission surface 410 and the vicinity of the point Pb1 are regions for emitting light for forming the virtual picture object Ib at a front side away from the windshield 18 by a distance (for example, about 15 m) that is longer than that of the position of the virtual picture object Ia.

For example, the external light incident onto the point Pa1 on the light emission surface 410 travels along the optical path La2, is reflected at the point Pa2 on the concave mirror 406, thereafter travels along the optical path La1, and is incident onto the point Pa1. On the other hand, for example, the external light incident onto the point Pb1 on the light emission surface 410 travels along the optical path Lb2, is reflected at the point Pb2 on the concave mirror 406, thereafter travels along the optical path Lb1, passes through the ND filter 407, and is incident onto the point Pb1 through the lens 405. As described above, since the external light incident onto the point Pb1 on the light emission surface 410 passes through the ND filter 407 after being reflected by the concave mirror 406, an amount of the external light is reduced by the ND filter 407.

As described above, the emission window 403 is a transparent plate that transmits light. Therefore, as shown in FIG. 3, when external light such as sunlight incident from the outside of the vehicle is incident into the housing 402 through the emission window 403, the external light may be reflected by the concave mirror 406 and may be radiated to the light emission surface 410 of the picture generation unit 404 in a converged state. When such converged external light is radiated to the light emission surface 410 of the picture generation unit 404, an excessive temperature rise in the light emission surface 410 may occur due to far-infrared rays included in the external light that is visible light, and the picture generation unit 404 may deteriorate. In particular, since the virtual picture object Ib is displayed at a position farther away from the vehicle 1 than the virtual picture object Ia, a converged light amount of external light reaching the picture generation unit 404 through an optical path in a region for emitting the second light for generating the virtual picture object Ib on the light emission surface 410 of the picture generation unit 404 is larger than that in a region for emitting the first light for generating the virtual picture object Ia, and a temperature rise is likely to occur.

On the other hand, the HUD 40 according to the first embodiment includes the picture generation unit 404 that emits the first light for generating the virtual picture object Ia (an example of the first picture) at a position away from the vehicle 1 by a predetermined distance (for example, about 3 m) and the second light for generating the virtual picture object Ib (an example of the second picture) at a position away from the vehicle 1 by a distance (for example, about 15 m) different from the predetermined distance, and the concave mirror 406 (an example of a reflection unit) that reflects the first light and the second light so that the first light and the second light emitted by the picture generation unit 404 are radiated to the windshield 18. The ND filter 407 (an example of a first optical element) for reducing transmittance of light including at least visible light to be lower than transmittance of the first light is provided between the picture generation unit 404 and the concave mirror 406 at a position through which the second light passes. According to this configuration, the ND filter 407 is provided on an optical path having a large converged light amount of external light reaching the picture generation unit 404, that is, a path through which the second light passes, so that it is possible to reduce the amount of external light incident into a region having a large converged light amount of the external light on the light emission surface 410 of the picture generation unit 404. Accordingly, it is possible to prevent the occurrence of heat damage caused by the converged external light being incident into a predetermined region of the light emission surface 410 of the picture generation unit 404, the occurrence of deterioration of the display device due to heat, or the like. Since the picture displayed as the virtual picture object Ib is a picture for night vision, even when an amount of the second light toward the occupant is reduced to be lower than an amount of the first light by providing the ND filter 407 on a path through which the second light passes, the virtual picture object Ib generated by light having the reduced light amount can be sufficiently recognized by an occupant, and the quality of the virtual picture object Ib is not lowered.

According to the HUD 40, the ND filter 407 is attached to the housing 402 of the HUD 40 between the picture generation unit 404 and the concave mirror 406. According to this configuration, the ND filter 407 can be provided at an appropriate position in the HUD 40 with a simple configuration.

According to the HUD 40, the lens 405 configured to change a focal length (apparent optical path length) of the second light emitted from the picture generation unit 404 is provided between the picture generation unit 404 and the concave mirror 406. According to this configuration, it is easy to achieve a configuration for displaying the virtual picture object Ib at a position farther than the virtual picture object Ia.

### Second Embodiment

FIG. 4 is a schematic diagram showing a function of an ND filter 407A in a HUD 140 according to a second embodiment.

As shown in FIG. 4, the HUD 140 according to the second embodiment is different from the HUD 40 according to the first embodiment in which the ND filter 407 is disposed between the picture generation unit 404 and the concave mirror 406 in that the ND filter 407A that reduces transmittance of light (for example, sunlight) including at least visible light is disposed between the concave mirror 406 and the windshield 18. The ND filter 407A is attached to the housing 402 in a manner of covering a part of a surface of the emission window 403 of the HUD main body 401.

The ND filter 407A is provided at a position through which a part of light passes, and the light is light that is emitted from the light emission surface 410 of the picture generation unit 404, passes through the lens 405, is reflected by the concave mirror 406, and travels toward the windshield 18. The ND filter 407A reduces the transmittance of light passing through the ND filter 407A. The ND filter 407A is provided at a position through which a part of external light passes, and the external light is light that is incident into the vehicle 1 from the outside of the vehicle and travels toward the concave mirror 406. The ND filter 407A reduces the transmittance of the external light passing through the ND filter 407A. The ND filter 407A is configured to reduce the transmittance of light passing through the ND filter 407A to 1% or more and 40% or less. The ND filter 407A is most effective when the transmittance of the light passing through the ND filter 407A can be reduced to 1.7% or more and 15% or less, and preferably 10% or less.

In the HUD 140, the ND filter 407A that reduces an amount of external light incident on the picture generation unit 404 is operated as follows.

The external light incident onto the point Pa1 on the light emission surface 410 of the picture generation unit 404 travels along the optical path La2, is reflected at the point Pa2 on the concave mirror 406, thereafter travels along the optical path La1, and is incident on the point Pa1. The point Pa1 on the light emission surface 410 and the vicinity of the point Pa1 are regions for emitting light for forming the virtual picture object Ia at a front side away from the windshield 18 by a relatively short predetermined distance (for example, about 3 m).

On the other hand, for example, the external light incident onto the point Pb1 on the light emission surface 410 of the picture generation unit 404 passes through the ND filter 407A provided at a portion of the emission window 403 when the external light is incident into the housing 402 through the optical path Lb2, is reflected at the point Pb2 on the concave mirror 406, thereafter travels along the optical path Lb1, passes through the lens 405, and is incident onto the point Pb1. The point Pb1 on the light emission surface 410 and the vicinity of the point Pb1 are regions for emitting light for forming the virtual picture object Ib at a front side away from the windshield 18 by a distance (for example, about 15 m) that is longer than that of the position of the virtual picture object Ia. In this manner, the external light that is incident onto the point Pb1 on the light emission surface 410 passes through the ND filter 407A and the point Pb1 on the light emission surface 410 is region for emitting light for forming the virtual picture object Ib at a position farther than the virtual picture object Ia, so that an amount of the external light incident onto the point Pb1 is reduced to be smaller than an amount of external light incident onto the point Pa1 on the light emission surface 410.

As described above, according to the HUD 140 in the second embodiment, the ND filter 407A is attached to the housing 402 between the concave mirror 406 and the windshield 18, and the ND filter 407A can reduce the amount of external light incident onto the point Pb1 on the light emission surface 410 that is a region having a large converged light amount of the external light. Accordingly, it is possible to prevent the occurrence of heat damage caused by external light having a high light amount being incident into a predetermined region of the light emission surface 410 of the picture generation unit 404. Although the temperature of the ND filter 407A rises by absorbing the external light, the ND filter 407A is provided at a portion of the emission window 403 separated from the picture generation unit 404, so that it is possible to prevent a temperature rise inside the housing 402 accompanying with the temperature rise of the ND filter 407A. Accordingly, it is possible to further prevent the occurrence of heat damage in the picture generation unit 404.

FIG. 5 is a schematic diagram showing a configuration of an HUD 240 according to a modification.

As shown in FIG. 5, the HUD 240 according to the modification includes the HUD main body 401 and a combiner 19. The combiner 19 is provided inside the windshield 18 as a structure separate from the windshield 18. The combiner 19 is, for example, a transparent plastic disk, and light reflected by the concave mirror 406 is radiated to the combiner 19 instead of the windshield 18. Accordingly, a part of the light radiated from the HUD main body 401 to the combiner 19 is reflected toward the viewpoint E of an occupant in a similar manner to the case where light is radiated to the windshield 18. As a result, the occupant can recognize the emitted light (a predetermined picture) from the HUD main body 401 as virtual picture objects Ia and Ib formed at a front side away from the combiner 19 (and the windshield 18) by a predetermined distance. Although the ND filter 407 is disposed between the picture generation unit 404 and the concave mirror 406 in FIG. 5, the ND filter 407 may be disposed between the concave mirror 406 and the combiner 19 as indicated by a broken line (reference numeral 407A).

In the case where the HUD 240 includes the combiner 19 as described above, the same effects as those of the HUD 40 according to the first embodiment and the HUD 140 according to the second embodiment can be achieved.

Although embodiments of the present invention have been described above, it is needless to say that the technical scope of the present invention should not be interpreted as being limited to the description of the embodiments. It is to be understood by those skilled in the art that the present embodiment is merely an example and various modifications may be made within the scope of the invention described in the claims. The technical scope of the present invention should be determined based on the scope of the inventions described in the claims and an equivalent scope thereof.

Although the ND filter 407 and the lens 405 are formed separately in the embodiments described above for the sake of convenience, the present invention is not limited to this example. For example, the lens 405 may have a function of an ND filter by coating a surface of the lens 405 with the ND filter. As in a HUD 40B shown in FIG. 6, an ND filter 407B may be attached to the picture generation unit 404 instead of the housing 402. Furthermore, although the ND filter 407A according to the second embodiment is attached to a front surface of the emission window 403, the ND filter 407A may be attached to a back surface of the emission window 403. According to these configurations as well, the ND filter can be easily mounted on a head-up display.

Although a configuration in which the transmittance of light is lowered by the ND filter 407 is adopted in the embodiments described above, the present invention is not limited to this example. For example, an openable/closable shutter that completely blocks light may be provided between the picture generation unit 404 and the concave mirror 406 or between the concave mirror 406 and the windshield 18 or the combiner 19. The display control unit 44 of the HUD 40 may be configured to control opening and closing of the shutter. The display control unit 44 opens the shutter when the HUD 40 is in operation, and closes the shutter when the HUD 40 is not in operation. In this manner, it is possible to reduce a total amount of external light incident on the light emission surface 410 of the picture generation unit 404 by opening and closing the shutter according to operation and non-operation of the HUD 40.

In the embodiments described above, the vehicle driving mode has been described as including the fully automatic driving mode, the advanced driving support mode, the driving support mode, and the manual driving mode, but the vehicle driving mode should not be limited to these four modes. The vehicle driving mode may include at least one of these four modes. For example, only one vehicle driving mode may be performed.

Further, a classification and display form of the vehicle driving mode may be appropriately changed according to laws or regulations related to automatic driving in each country. Similarly, definitions of the “fully automatic driving mode”, the “advanced driving support mode”, and the “driving support mode” described in the description of the present embodiments are merely examples, and the definitions may be appropriately changed according to the laws and the regulations related to the automatic driving in each country.

The present application is based on Japanese Patent Application NO. 2019-170539 filed on Sep. 19, 2019, the contents of which are incorporated herein by reference.

1. A head-up display that is provided in a vehicle and configured to display predetermined pictures toward an occupant of the vehicle, the head-up display comprising:
a picture generation unit configured to emit first light for generating a first picture at a position away from the vehicle by a predetermined distance, and second light for generating a second picture at a position away from the vehicle by a distance different from the predetermined distance, among the predetermined pictures; and
a reflection unit configured to reflect the first light and the second light so that the first light and the second light emitted by the picture generation unit are radiated to a windshield or a combiner,
wherein a first optical element that reduces transmittance of light including at least visible light to be lower than transmittance of the first light is provided between the picture generation unit and the windshield or the combiner at a position through which the second light passes.

2. The head-up display according to claim 1,
wherein the first optical element is provided between the picture generation unit and the reflection unit at a position through which the second light passes.

3. The head-up display according to claim 1,
wherein the first optical element is provided between the reflection unit and the windshield or the combiner at a position through which the second light passes.

4. The head-up display according to claim 2, further comprising:
a housing that accommodates the picture generation unit and the reflection unit,
wherein the first optical element is attached to the housing.

5. The head-up display according to claim 2,
wherein the first optical element is attached to the picture generation unit.

6. The head-up display according to claim 1,
wherein the first optical element is an optical filter configured to reduce an amount of external light incident on the picture generation unit.

7. The head-up display according to claim 1,
wherein a position at which the second picture is generated is farther from the vehicle than a position at which the first picture is generated.

8. The head-up display according to claim 7,
wherein a second optical element for displaying the second picture is provided between the picture generation unit and the reflection unit at a position farther from the vehicle than the position at which the first picture is displayed.

9. A picture display system comprising:
the head-up display according to claim 1;
an IR lamp configured to radiate infrared light to an outer side of the vehicle; and
an IR camera configured to capture a picture of the outer side of the vehicle irradiated with the infrared light,
wherein the second picture is generated based on the picture captured by the IR camera.
